(19) United States
(12) Patent Application Publication
(10) Pub. No.: US 2026/0183967 A1
(43) Pub. Date: Jul. 2, 2026

(54) ROBOTIC SYSTEM FOR GROUND PENETRATING RADAR INSPECTION

(71) Applicant: UNIVERSITY OF SHARJAH, Sharjah (AE)

(72) Inventors: Saleh ABU DABOUS, Sharjah (AE); Mohamed Ait GACEM, Sharjah (AE)

(21) Appl. No.: 19/432,365

(22) Filed: Dec. 24, 2025

Related U.S. Application Data
(60) Provisional application No. 63/740,517, filed on Dec. 31, 2024.

(51) Int. Cl. B25J 11/00; B25J 5/00; B25J 9/00; B25J 19/02

(52) U.S. Cl. CPC B25J 11/005; B25J 5/007; B25J 9/0009; B25J 19/023

(57) ABSTRACT

The present disclosure provides a robotic system for ground penetrating radar inspection. The robotic system comprises a main body and a plurality of wheel assemblies connected to the main body, each wheel assembly comprising an arm and a wheel located at a distal end of the arm. The robotic system further comprises an excavation assembly connected to the main body, the excavation assembly comprising an actuator and an excavation tool operably movable by the actuator. Each arm of each wheel assembly is connected to the main body by a servo motor assembly, such that each arm of each wheel assembly has two degrees of freedom relative to the main body. The robotic system enables inspection of confined spaces and underground rescue operations by combining ground penetrating radar technology with enhanced mobility capabilities and excavation functionality to access previously inaccessible underground areas.

### FIELD OF INVENTION

The present disclosure relates to robotic systems for ground penetrating radar inspection, and more particularly to a robotic system with articulated wheel assemblies and excavation capabilities for inspecting confined spaces and conducting underground rescue operations.

### BACKGROUND

Ground Penetrating Radar (GPR) technology has become a widely adopted non-destructive inspection technique in civil engineering applications, including evaluation of pipelines, underground utilities, pavement structures, and various oil and gas industry operations. GPR systems utilize electromagnetic waves to detect and image subsurface features, providing valuable information about buried infrastructure, geological formations, and potential anomalies without the need for excavation or drilling.

Traditional GPR inspection methods typically employ surface-based platforms such as wheeled carts, vehicles, or aerial drones to carry and position GPR antennas. While these conventional approaches have proven effective for many surface-level scanning applications, they face limitations when attempting to access confined or restricted spaces. The physical constraints of existing GPR antenna carrying platforms often prevent thorough inspection of tight underground areas, narrow passages, and deep subterranean environments where detailed subsurface information may be particularly valuable. The ability to conduct GPR inspections in confined spaces presents opportunities for enhanced infrastructure assessment, hazard identification, and archaeological investigation. Access to previously unreachable areas could enable more comprehensive evaluation of subsurface structures, materials, and anomalies. Such capabilities would be particularly beneficial for assessing infrastructure integrity in challenging environments and supporting various exploration activities.

Additionally, emergency response and rescue operations in underground environments present unique challenges where traditional inspection and communication methods may be inadequate. Situations involving individuals trapped in subterranean locations often require rapid assessment of underground conditions and the ability to deliver aid through confined passages. Current technologies may lack the mobility and adaptability needed to navigate complex underground terrain while maintaining operational functionality. The development of more agile and adaptable systems for GPR inspection and underground operations could address these technological gaps. Such systems would benefit from enhanced maneuverability, the ability to navigate obstacles, and sufficient structural flexibility to operate effectively in constrained environments while maintaining the precision and reliability required for accurate subsurface imaging and emergency response applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In accordance with the present invention, a robotic system for ground penetrating radar inspection is disclosed, comprising a main body, a plurality of wheel assemblies connected to the main body, each wheel assembly comprising an arm and a wheel located at a distal end of the arm; and an excavation assembly connected to the main body, the excavation assembly comprising an actuator and an excavation tool operably movable by the actuator-wherein each arm of each wheel assembly is connected to the main body by a servo motor assembly, such that each arm of each wheel assembly has two degrees of freedom relative to the main body.

In an embodiment of the present invention, the plurality of wheel assemblies comprises four-wheel assemblies.

In another embodiment of the present invention, the servo motor assembly comprises a first servo motor configured to control right-left rotation of the arm relative to the main body and a second servo motor configured to control up-down rotation of the arm relative to the main body.

In another embodiment of the present invention, each wheel is movable relative to the respective arm, and each wheel is movable in two degrees of freedom relative to the respective arm.

In another embodiment of the present invention, each wheel is connected to the respective arm by a pair of servo motors that provide the two degrees of freedom for wheel movement.

In another embodiment of the present invention, the excavation tool comprises an excavation blade and a drilling motor attached to the excavation blade, and the actuator comprises a linear actuator configured to move the drilling motor in a straight line in a left-right direction.

In another embodiment of the present invention, the disclosed robotic system further comprises a ground penetrating radar antenna mounted on the main body, and a plurality of depth cameras mounted on the main body.

In another embodiment of the present invention, the disclosed robotic system further comprises a plurality of flashlights configured to provide illumination for the plurality of depth cameras.

As another aspect of the present invention, a method of performing ground penetrating radar inspection is disclosed, comprising deploying a robotic system, the robotic system comprising a main body and a plurality of wheel assemblies, each wheel assembly comprising an arm and a wheel located at a distal end of the arm, actuating at least one arm via a servo motor assembly and moving the arm in two degrees of freedom relative to the main body; and excavating a section of ground using an excavation assembly connected to the main body.

In an embodiment of the present invention, the method further comprises collecting ground penetrating radar data from underground layers using a ground penetrating radar antenna mounted on the main body.

In an embodiment of the present invention, the method further comprises a step of analyzing video feed from a plurality of depth cameras to determine suitable spatial variation directions for navigating through underground passages.

In an embodiment of the present invention, the method further comprises delivering aid materials to individuals trapped in subterranean locations using an aid package dropping mechanism.

As another aspect of the present invention, a robotic system for underground rescue operations is disclosed, comprising a main body housing a ground penetrating radar antenna; four wheel assemblies connected to the main body, each wheel assembly comprising an arm and a wheel located at a distal end of the arm, wherein each arm is connected to the main body by a servo motor assembly providing two degrees of freedom relative to the main body, an excavation assembly connected to the main body and comprising a drilling motor, an excavation blade attached to the drilling motor, and a linear actuator configured to move the drilling motor; and an aid package dropping mechanism comprising a servo motor and an attachment rod configured to secure and release aid materials.

In an embodiment of the present invention, the servo motor assembly comprises a first servo motor configured to control right-left rotation of the arm relative to the main body and a second servo motor configured to control up-down rotation of the arm relative to the main body.

In an embodiment of the present invention, each wheel is movable in two degrees of freedom relative to the respective arm via a pair of servo motors.

In another embodiment of the present invention, the robotic system further comprises a scorpion-tail robotic camera arm connected to the main body, the scorpion-tail robotic camera arm comprising a long-range depth camera attached through a long rod to servo motors that provide two degrees of freedom for camera positioning.

In another embodiment of the present invention, the servo motor of the aid package dropping mechanism is configured to perform a 90-degree rotation of the attachment rod to release aid materials selected from the group consisting of first aid supplies, food, water, rescue ropes, and oxygen pipes.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures. The manner in which the above-recited features of the present invention is understood in detail, a more particular description of the invention, briefly summarized above, may be had by reference to embodiments, some of which are illustrated in the appended drawings. It is to be noted, however, that the appended drawings illustrate only typical embodiments of the present disclosure and are therefore not to be considered limiting of its scope, for the present disclosure may admit to other equally effective embodiments.

FIG. 1 shows a front view of the robotic system according to an embodiment of the present disclosure.

FIGS. 2A and 2B show a back view of the robotic system according to an embodiment of the present disclosure.

FIG. 3 shows an illustration of the main body of the robotic system according to an embodiment of the present disclosure.

FIG. 4 shows an illustration of the main body of the robotic system according to an embodiment of the present disclosure.

FIGS. 5A-5C show an illustration of the path carving mechanism in various positions according to an embodiment of the present disclosure.

FIG. 6 shows the servo motors controlling the wheels according to an embodiment of the present disclosure.

FIG. 7 shows the servo motors controlling the robotic arms according to an embodiment of the present disclosure.

FIGS. 8A-8D show the upper left arm and wheel of the robotic system in various positions according to an embodiment of the present disclosure.

FIG. 9A-9D show the upper left arm and wheel of the robotic system in various positions according to an embodiment of the present disclosure.

FIG. 10 shows an illustration of the robotic system positioned on a ground surface according to an embodiment of the present disclosure.

FIGS. 11A-11C show an illustration of the servo motors controlling the wheel's rotation according to an embodiment of the present disclosure.

FIG. 12 shows an illustration of the controlling circuits according to an embodiment of the present disclosure.

FIG. 13 shows the aid package attachment and detachment mechanism according to an embodiment of the present disclosure.

FIGS. 14A-14D show an illustration of the aid dropping mechanism according to an embodiment of the present disclosure.

FIG. 15A-15C show an illustration of the rescue ropes or oxygen pipes dropping mechanisms according to an embodiment of the present disclosure.

FIGS. 16A and 16B show the scorpion-tail camera arm control mechanism according to an embodiment of the present disclosure.

FIGS. 17A-17C show the right-left rotation mechanism of the scorpion-tail camera arm according to an embodiment of the present disclosure.

FIGS. 18A-18C show the up-down rotation mechanism of the scorpion-tail camera arm according to an embodiment of the present disclosure.

FIG. 19 shows the camera holder servo motors according to an embodiment of the present disclosure.

FIGS. 20A-20C show the camera holder right-left rotation mechanism according to an embodiment of the present disclosure.

FIGS. 21A-21E show the camera holder right-left actuation mechanism according to an embodiment of the present disclosure.

FIG. 22 shows an illustration of the robotic system in a simulated environment according to an embodiment of the present disclosure.

FIGS. 23A-23E show robotic system carving a path through a ground opening according to an embodiment of the present disclosure.

FIGS. 24A-24D show the robotic system performing manipulations on the robotic arms according to an embodiment of the present disclosure.

FIG. 25 shows the robotic system collecting GPR readings from underground layers according to an embodiment of the present disclosure.

FIG. 26 shows the robotic system passing through a vertical path according to an embodiment of the present disclosure.

FIGS. 27A-27C show an illustration of the robotic system carving a path through underground layers according to an embodiment of the present disclosure.

FIGS. 28A-28C show an illustration of the robotic system avoiding path obstacles according to an embodiment of the present disclosure.

FIG. 29 shows the robotic system arriving at a trapped individual according to an embodiment of the present disclosure.

FIGS. 30A-30C show an illustration of the aid package release mechanism according to an embodiment of the present disclosure.

FIG. 31 shows the robotic system delivering aid to a trapped individual according to an embodiment of the present disclosure.

FIG. 32 shows the robotic system delivering rescue ropes or oxygen piped to a trapped individual according to an embodiment of the present disclosure.

FIG. 33 shows the robotic system performing complex underground spatial manipulations according to an embodiment of the present disclosure.

FIG. 34 shows a flowchart of the operation of the robotic system according to an embodiment of the present disclosure.

The foregoing and other objects, features and advantages of the present invention, as well as the invention itself, will be more fully understood from the following description of preferred embodiments, when read together with the accompanying drawings.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

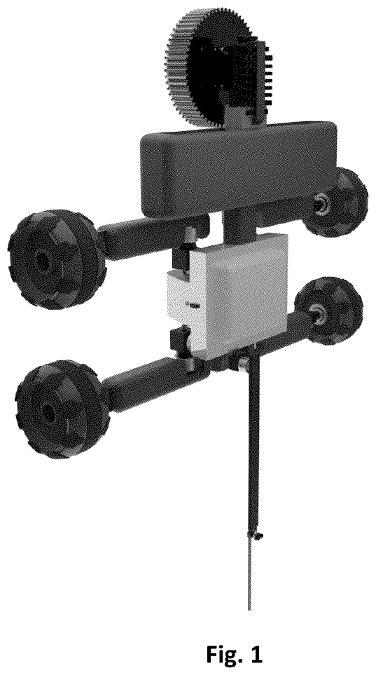

The principles of the present invention and their advantages are best understood by referring to FIG. 1 to FIG. 34. In the following detailed description of illustrative or exemplary embodiments of the disclosure, specific embodiments in which the disclosure may be practiced are described in sufficient detail to enable those skilled in the art to practice the disclosed embodiments. The following detailed description is, therefore, not to be taken in a limiting sense, and the scope of the present disclosure is defined by the appended claims and equivalents thereof. References within the specification to “one embodiment,” “an embodiment,” “embodiments,” or “one or more embodiments” are intended to indicate that a particular feature, structure, or characteristic described in connection with the embodiment is included in at least one embodiment of the present disclosure. The terms “arms” and “legs” or “arm” and “leg” may be used interchangeably throughout the detailed description.

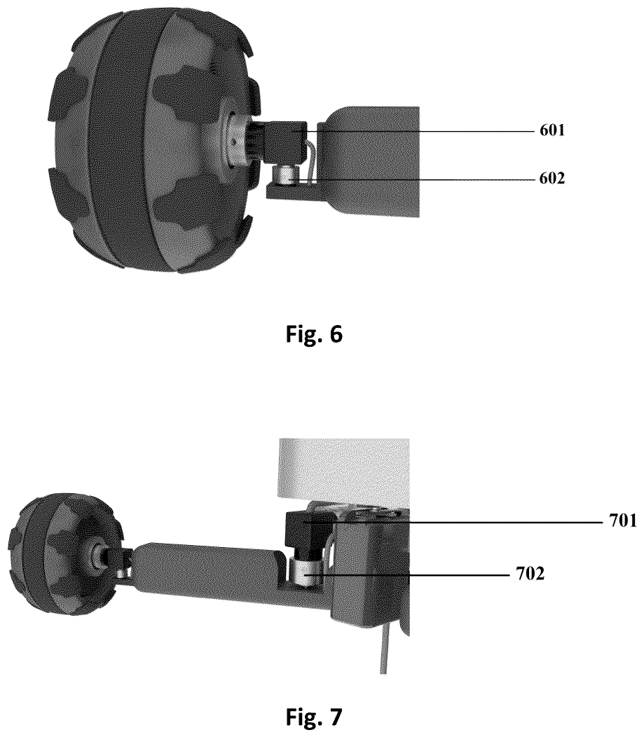

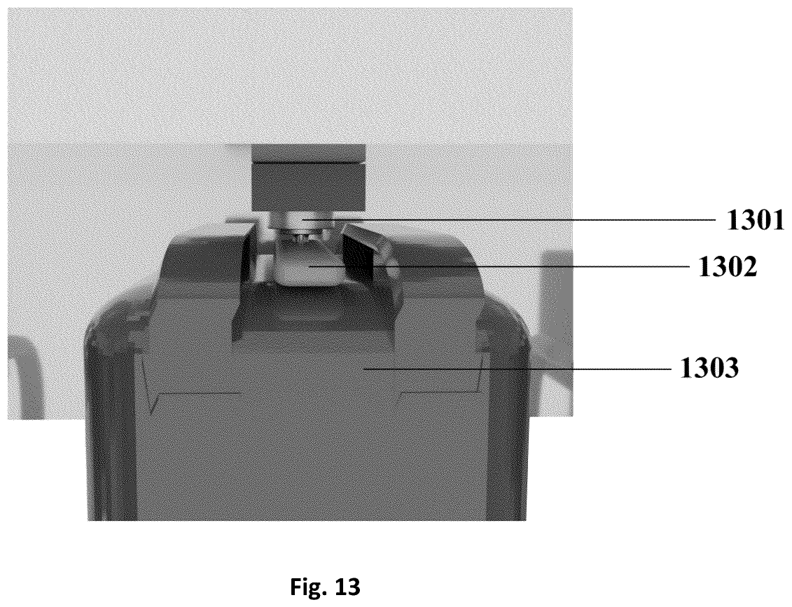

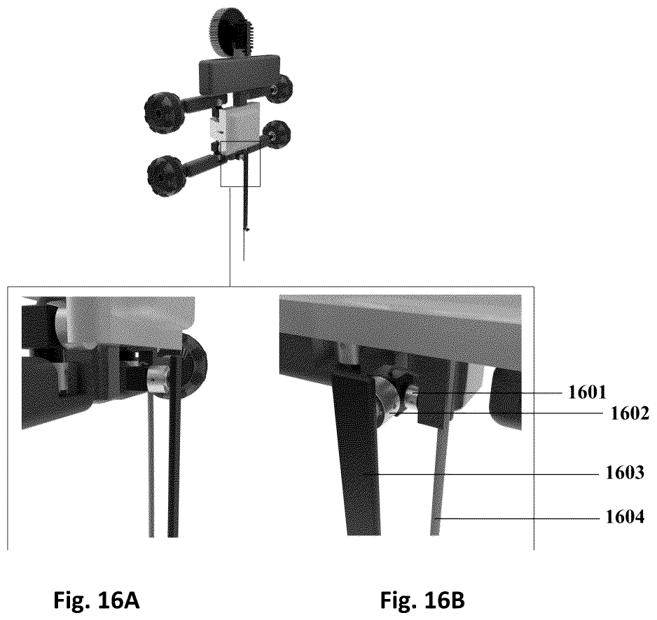

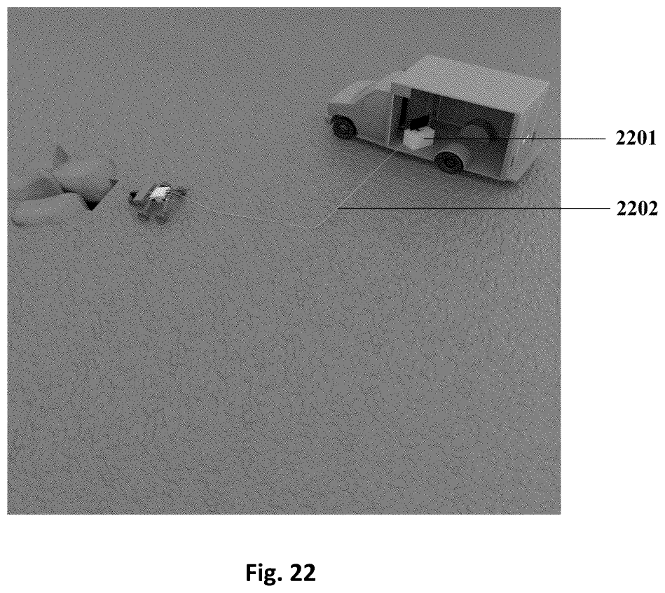

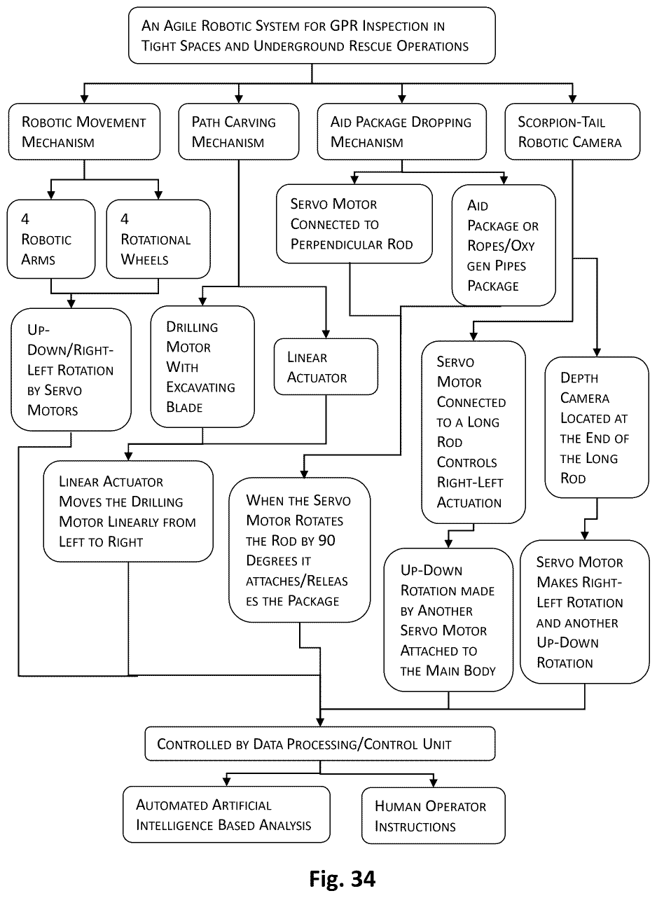

The robotic system described in embodiments of the present disclosure is related to an agile robotic system engineered with multiple degrees of spatial freedom and structural flexibility, tailored for inspecting confined spaces utilizing Ground Penetrating Radar (GPR) technology as shown in (FIGS. 22-26). In addition, the embodiments of the present disclosure are designed to carve a path through underground layers and navigate obstacles to deliver aid during rescue missions to individuals trapped in underground layers as illustrated in (FIGS. 22-33). The robotic system described in embodiments of the present disclosure consists of 4 major components: robotic arms (406) and rotational wheels (407) (FIGS. 6-11), path carving mechanism (FIG. 5), aid package dropping mechanism (FIGS. 13-15), main body (304), GPR antenna (305) and control circuits (1202), and scorpion-tail robotic camera arm (FIGS. 16-21). A summarized workflow is presented in FIG. 34.

FIG. 1 shows a front view of the robotic system according to an embodiment of the present disclosure.

The robotic system has a main body, an actuator for the excavation tool, and an excavation tool used for clearing a subterranean path for the robotic system. Also attached to the main body are four arms, with a wheel attached to each distal end of each arm. Connecting each arm to the main body is a servo motor assembly. Each servo motor assembly comprises two servo motors, allowing the arm to rotate with two degrees of freedom relative to the main body. Each wheel is also connected to each respective distal end of each arm by a servo motor, enabling each wheel to rotate with one degree of freedom relative to the respective arm. In embodiments, each wheel is connected to each respective distal end of each arm by a pair of servo motors, such that each wheel is able to rotate with two degrees of freedom relative to the respective arm. This results in an agile robotic system engineered with structural flexibility tailored for inspecting confined spaces utilizing Ground Penetrating Radar (GPR) technology.

This system has dual functionality, where besides conducting thorough GPR inspections in tight spaces it serves as a pivotal asset in rescue operations. With the capability to navigate tight underground areas, it becomes a lifeline for individuals trapped in subterranean layers, swiftly delivering essential aid such as first aid, food and water, rescue ropes and oxygen masks. Furthermore, the robot's agility enables it to carve pathways, easing the extraction process for rescuers and ensuring the safe retrieval of those in distress. With such dual functionality, the presented robotic system ensures cost effectiveness and efficiency, enhances safety by minimizing the need for human entry into hazardous environments and achieves quick response during rescue missions. The robot's versatility makes it valuable in various scenarios, from routine inspections to high-stakes rescues. Additionally, in embodiments, operators can remotely control the robot, allowing real-time monitoring thus enhancing safety, while also featuring artificial intelligence-driven automation.

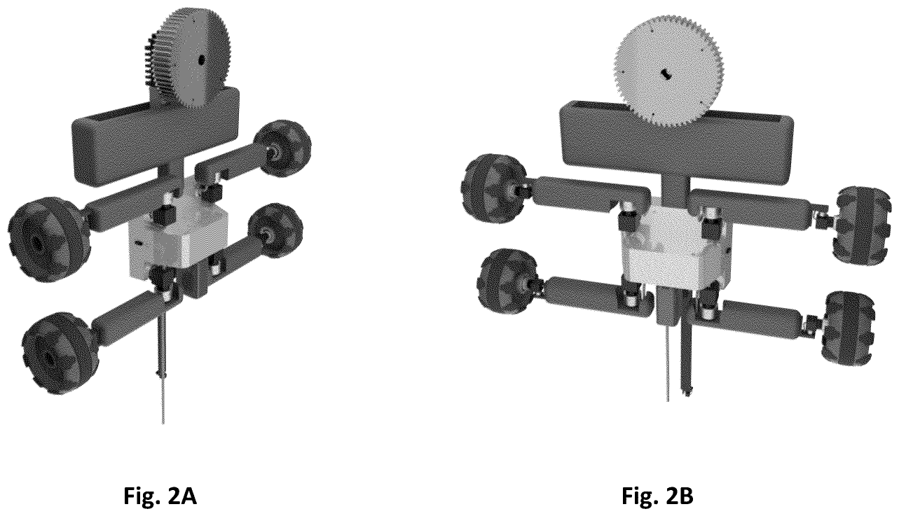

The robotic according to embodiments of the present disclosure dynamically delivers the GPR antenna into tight spaces or deep underground layers. This capability not only enhances rescue missions but also opens the door for further exploiting GPR readings. By navigating previously inaccessible areas, the system according to embodiments of the present disclosure has the potential to uncover new anomalies, discover minerals for commercial purposes, and perform more accurate overall measurements. Such system marks a significant leap forward in the utilization of GPR technology in both inspection and rescue scenarios, promising expanded possibilities for exploration, research and discovery in various fields. FIGS. 2A and 2B show a back view of the robotic system according to an embodiment of the present disclosure.

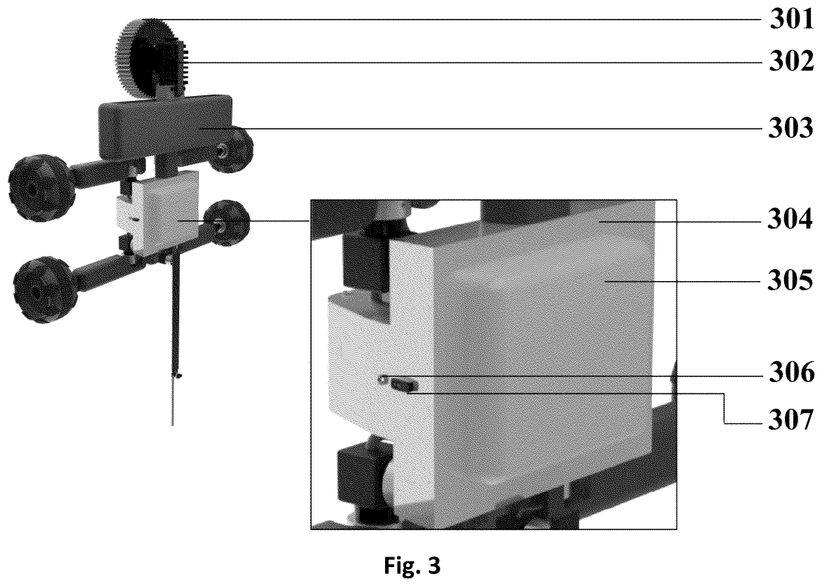

FIG. 3 shows an illustration of the main body of the robotic system according to an embodiment of the present disclosure. The robotic system has a path carving mechanism consisting of an excavation blade (301), drilling motor (302) and linear actuator (303). The drilling motor (302) with the attached excavation blade (301), controlled by the data processing/control circuit (1202), operates at high speed to dismantle the obstacles residing in the robot's path into small fragments. A linear actuator (303) moves the drilling motor (302) in a straight line in the left-right direction to clear the path. The linear actuator enables the excavation blade to change its position relative to the robotic system, so that it can dismantle the path in an optimal fashion. There is also provided a main body (304) and GPR antenna (305). The robot is equipped with multiple flashlights (306) to illuminate the path and ensure the optimum decision making. The robotic system also uses computer vision to analyze the path video feed obtained through the main body depth cameras (307).

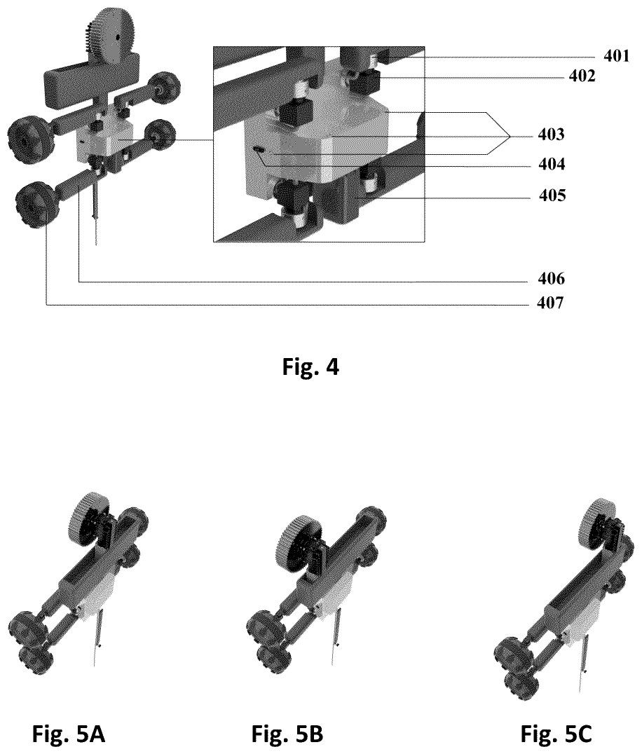

FIG. 4 shows an illustration of the main body of the robotic system according to an embodiment of the present disclosure. The robotic system comprises 4 robotic arms (406) which perform right-left rotation controlled by servo motors (401) (702). In addition, the robotic arms (406) perform up-down rotation using another set of servo motors (402) (701) connected to the main body (304). All servo motors are controlled using the data processing/control circuit (1202), which receives human operator instructions (2201) transmitted wirelessly via the Tx/Rx circuit (1204) or through a data cable (1604) (2202). Alternatively, the data processing/control circuit (1202) performs artificial intelligence-driven evaluations to determine the suitable spatial variation direction and degree required to pass through the desired path. It relies on computer vision to analyze the path video feed obtained through the main body depth cameras (307) (404), drill motor (302) mounted depth camera, and the scorpion-tail robotic arm depth camera. Such video feed is also transmitted to the human operator (2201) either wirelessly through the Tx/Rx circuit (1204) or through the data cable (1604) (2202). The robot is equipped with multiple flashlights (306) (403) to illuminate the path and ensure the optimum decision making. In addition, the robot is powered either through the data cable (1604) (2202) which carries in parallel a power cable, or it relies on the power provided by the on-board battery (1201) and voltage regulator circuit (1203). The robot is also equipped with a GPS module (1205) to facilitate its extraction.

Each robotic arm (406) is connected to a wheel (407), whose rotation is controlled with servo motors in the right-left and up-down directions (601) (602). The robotic system is designed to carry an aid package (405) (1303) to trapped individuals.

The robotic system can perform various robotic arm (406)-wheel (407) rotation variations to fit inside the inspected path, avoid obstacles and adjust the path carving process (FIG. 5). In addition to tight spaces inspection, the robotic arms (406) and wheels (407) can be adjusted in such way, where they can perform flat surface evaluation as illustrated in FIG. 10.

FIGS. 5A-5C show an illustration of the path carving mechanism in various positions according to an embodiment of the present disclosure.

The path carving mechanism moves left and right relative to the robotic system so that a complete path can be cleared for the robot to fit therein.

FIG. 6 shows the servo motors controlling the wheels according to an embodiment of the present disclosure. Each robotic arm (406) is connected to a wheel (407), whose rotation is controlled with servo motors in the right-left and up-down directions (601) (602). There are two servo motors enabling the wheel to move in two degrees of freedom relative to the arm.

In embodiments, there is one servo motor per wheel.

FIG. 7 shows the servo motors controlling the robotic arms according to an embodiment of the present disclosure.

The robotic system comprises four robotic arms (406) which perform right-left rotation using a servo motor (401) (702). In addition, the robotic arms (406) perform up-down rotation using another servo motor (402) (701) connected to the main body (304). This enables the arm to have two degrees of freedom relative to the main body of the robotic system. All servo motors are controlled using the data processing/control circuit (1202), which receives instructions wirelessly via the Tx/Rx circuit (1204) or through human operator instructions (2201) transmitted via a data cable (1604) (2202) or performs artificial intelligence-driven evaluations to determine the suitable spatial variation needed to fit the path.

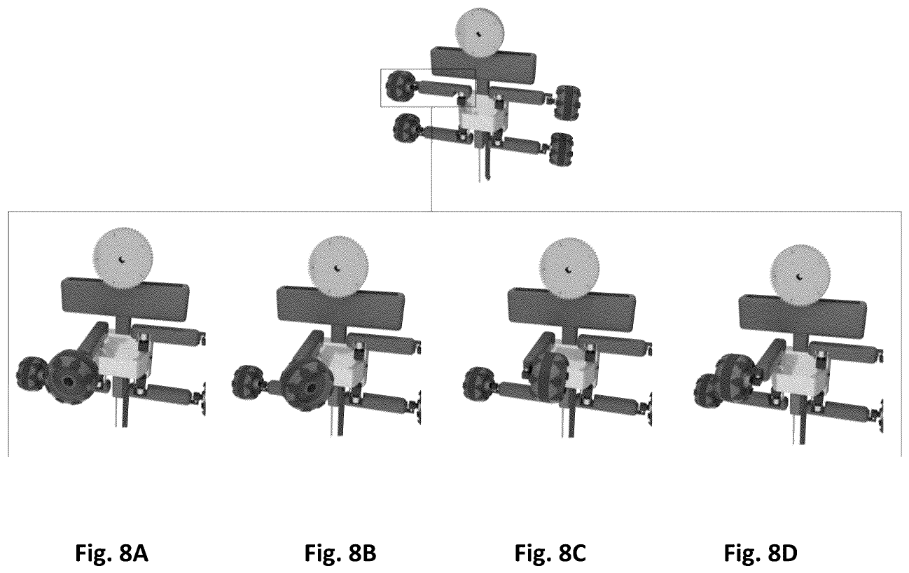

FIGS. 8A-8D show the upper left arm and wheel of the robotic system in various positions according to an embodiment of the present disclosure.

The upper left robotic arm moves by 90 degrees to the back side (FIG. 8A). The robot performs wheel rotation by 45-degrees counterclockwise (FIG. 8B). The robot completes a 90-degree wheel rotation counterclockwise (FIG. 8C). The robot performs a 180-degree wheel rotation clockwise (FIG. 8D).

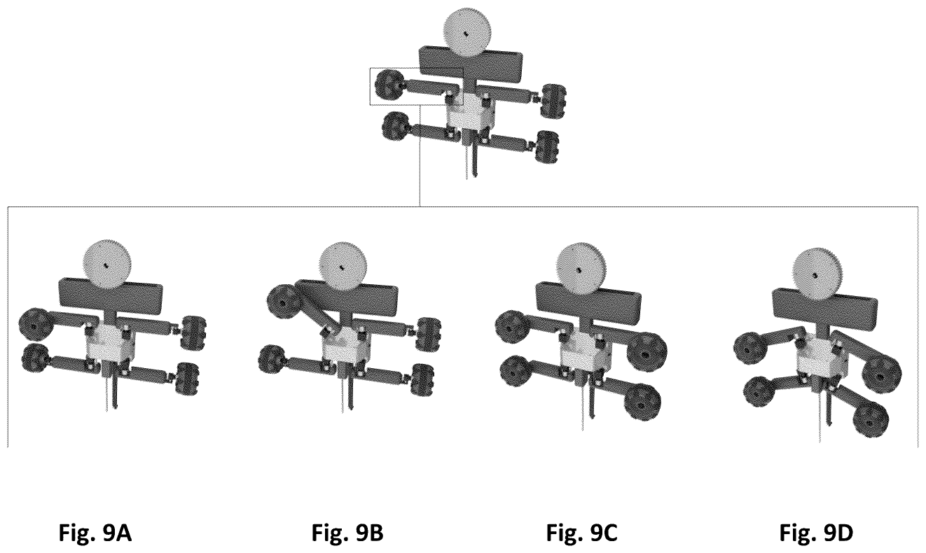

FIG. 9A-9D show the upper left arm and wheel of the robotic system in various positions according to an embodiment of the present disclosure.

The robot rotates the upper left wheel orientation by 90-degrees (FIG. 9A). The robotic arm rotates upwards by 45-degrees (FIG. 9B). The robot performs 90-degree rotation of all wheels (FIG. 9C). The robot performs robotic arm downwards rotation by 45-degrees (FIG. 9D).

FIG. 10 shows an illustration of the robotic system positioned on a ground surface according to an embodiment of the present disclosure.

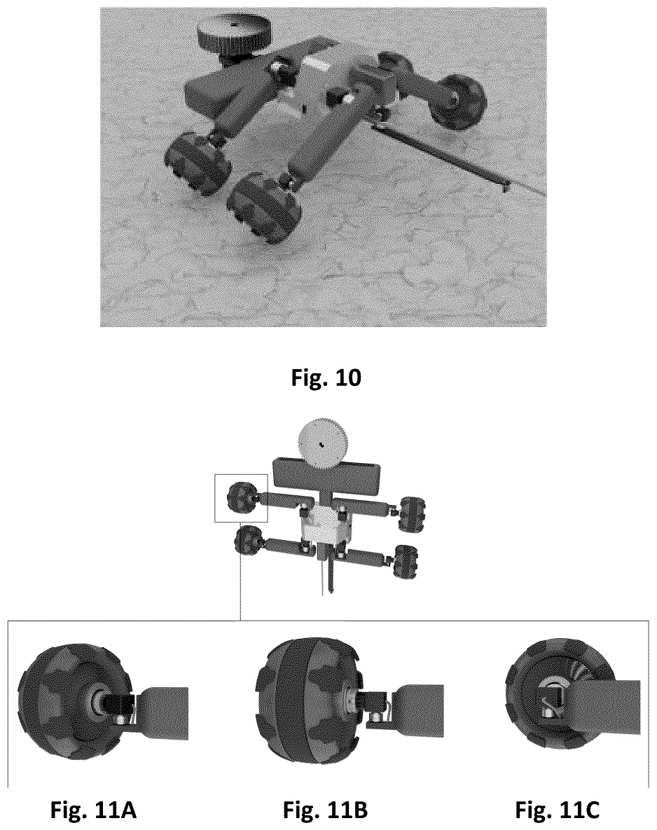

FIGS. 11A-11C show an illustration of the servo motors controlling the wheel's rotation according to an embodiment of the present disclosure.

FIG. 11A shows the wheel at a 45-degree rotation. FIG. 11B shows the wheel in the normal or neutral position. FIG. 11C shows the wheel at a 90-degree rotation.

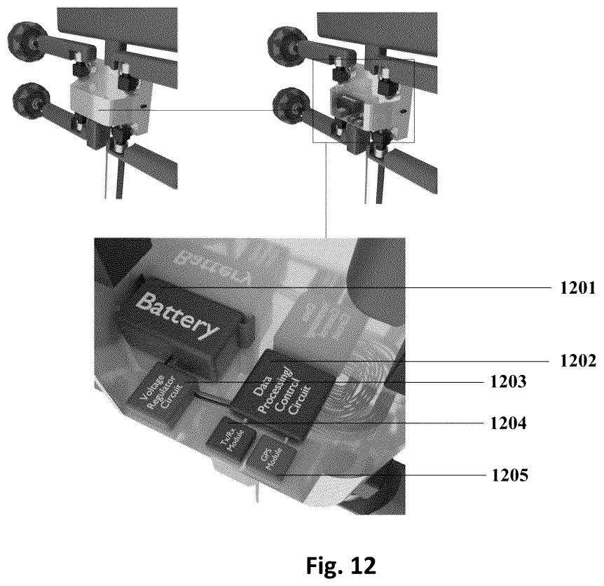

FIG. 12 shows an illustration of the controlling circuits according to an embodiment of the present disclosure. All servo motors are controlled using the data processing/control circuit (1202), which receives human operator instructions (2201) transmitted wirelessly via the Tx/Rx circuit (1204) or through a data cable (1604) (2202). Alternatively, the data processing/control circuit (1202) performs artificial intelligence-driven evaluations to determine the suitable spatial variation direction and degree required to pass through the desired path. It relies on computer vision to analyze the path video feed obtained through the main body depth cameras (307) (404), drill motor (302) mounted depth camera, and the scorpion-tail robotic arm depth camera. Such video feed is also transmitted to the human operator (2201) either wirelessly through the Tx/Rx circuit (1204) or through the data cable (1604) (2202). The robot is equipped with multiple flashlights (306) (403) to illuminate the path and ensure the optimum decision making. In addition, the robot is powered either through the data cable (1604) (2202) which carries in parallel a power cable, or it relies on the power provided by the on-board battery (1201) and voltage regulator circuit (1203). The robot is also equipped with a GPS module (1205) to facilitate its extraction.

FIG. 13 shows the aid package attachment and detachment mechanism according to an embodiment of the present disclosure. The robotic system is designed to carry an aid package (405) (1303) to trapped individuals. The aid package (405) (1303) is secured to the main body (304) using a rod (1302) attached to a servo motor (1301). When the servo motor (1301) rotates the rod (1302) by 90-degrees, the package (405) (1303) gets detached from the main body (304).

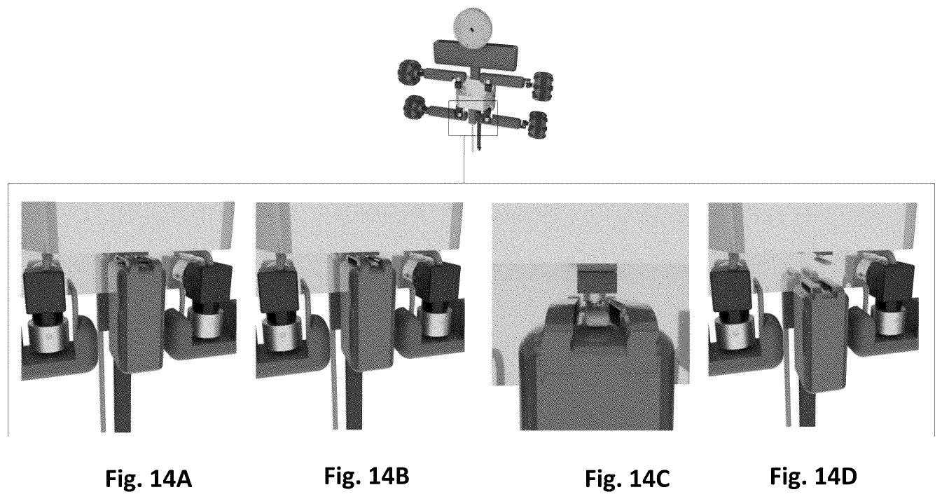

FIGS. 14A-14D show an illustration of the aid dropping mechanism according to an embodiment of the present disclosure.

The figures sequentially show the servo motor rotating the attachment rod by 90 degrees, releasing the package holder, and dropping the package, respectively.

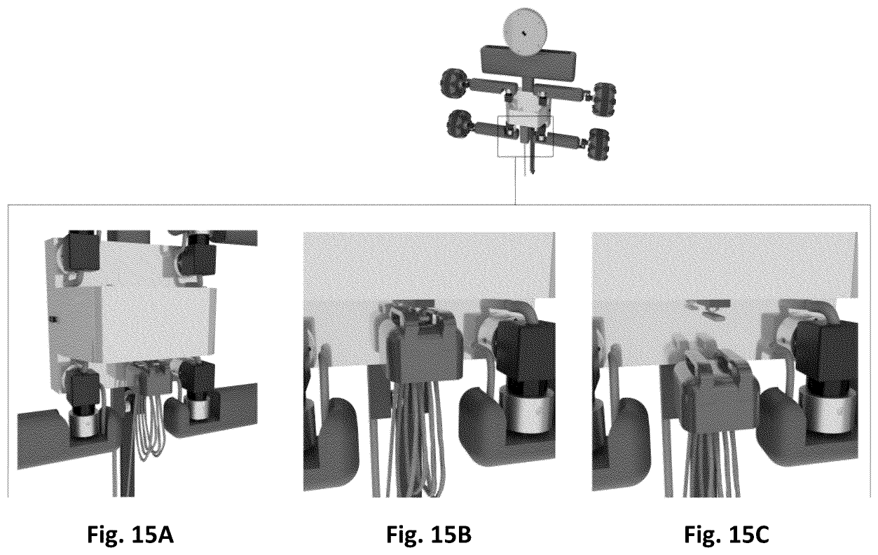

FIG. 15A-15C show an illustration of the rescue ropes or oxygen pipes dropping mechanisms according to an embodiment of the present disclosure.

The figures sequentially show the servo motor rotating the attachment rod by 90 degrees thus releasing the package holder, and dropping the rescue ropes or oxygen pipes, respectively.

FIGS. 16A and 16B show the scorpion-tail camera arm control mechanism according to an embodiment of the present disclosure. The servo motor controls right-left rotation, while another perpendicular servo motor controls up-down rotations, enabling the scorpion-tail arm to move in two degrees of freedom. The robotic system comprises a long-range depth camera attached through a long rod (1603) to servo motors (1601) (1602) in the main body (304), which mimics the scorpion tail. A servo motor (1602) controls left-right rotation of the long rod. Another perpendicular servo motor (1601) controls up-down rotations.

In addition to the long rod's (1603) spatial variation, the camera holder itself is equipped with a servo motor-based left-right (1902) and up-down (1901) rotation mechanisms to achieve the best field of view coverage.

The instructions are sent to the robotic system via the data cable (1604).

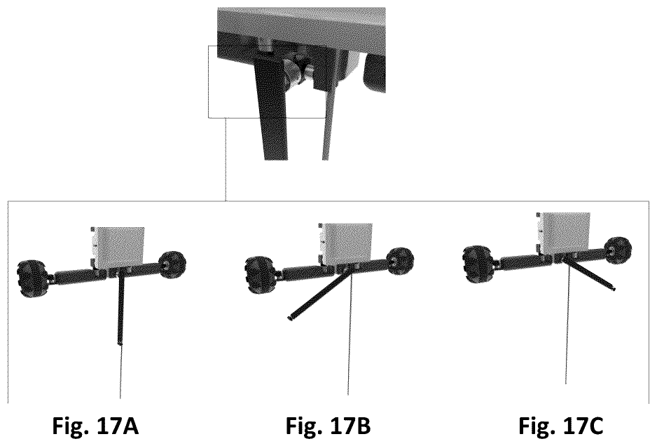

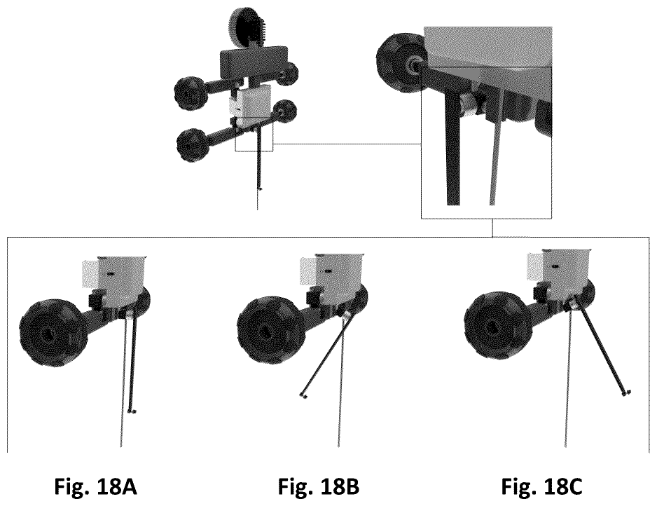

FIGS. 17A-17C show the right-left rotation mechanism of the scorpion-tail camera arm according to an embodiment of the present disclosure.

The scorpion tail arm is in the normal/neutral position (FIG. 17A), left rotation (FIG. 17B), and right rotation (FIG. 17C).

FIGS. 18A-18C show the up-down rotation mechanism of the scorpion-tail camera arm according to an embodiment of the present disclosure.

The scorpion tail arm is in the normal/neutral position (FIG. 18A), down rotation (FIG. 18B), and up rotation (FIG. 18C).

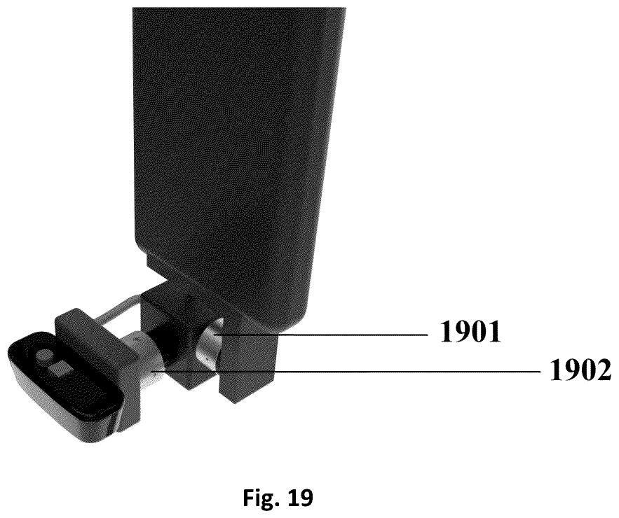

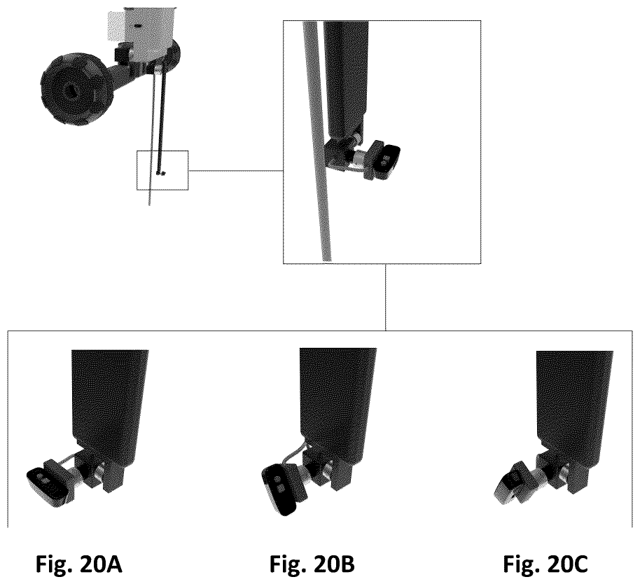

FIG. 19 shows the camera holder servo motors according to an embodiment of the present disclosure. In addition to the long rod's (1603) spatial variation, the camera holder itself is equipped with a servo motor-based left-right (1902) and up-down (1901) rotation mechanisms to achieve the best field of view coverage.

FIGS. 20A-20C show the camera holder right-left rotation mechanism according to an embodiment of the present disclosure.

The camera holder is in the normal/neutral position (FIG. 20A), right rotation by 45 degrees (FIG. 20B), and left rotation by 45 degrees (FIG. 20C).

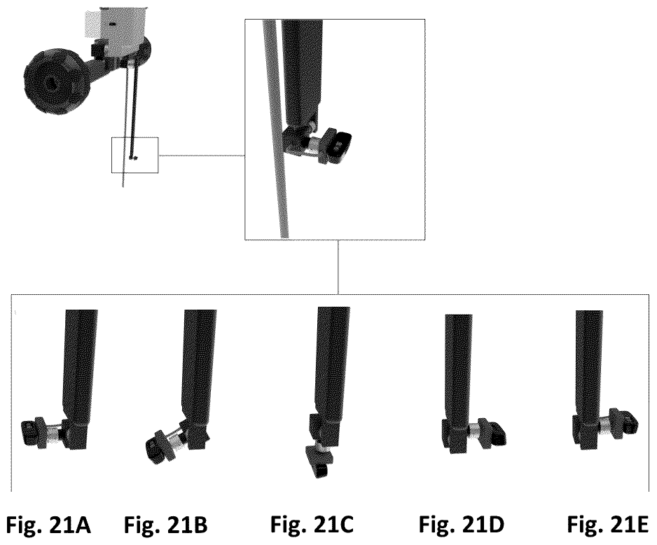

FIGS. 21A-21E show the camera holder right-left actuation mechanism according to an embodiment of the present disclosure.

The camera holder is in the normal/neutral position (FIG. 21A), down rotation by 45 degrees (FIG. 21B), down rotation by 90 degrees (FIG. 21C), up rotation by 90 degrees (FIG. 21D), and 180-degree rotation of the camera to face the upper scene (FIG. 21E).

FIG. 22 shows an illustration of the robotic system in a simulated environment according to an embodiment of the present disclosure. The robotic system operates in automated/remotely controlled modes, where the spatial manipulations of the robotic arms (406) and rotational wheels (407) are performed either through human operator instructions (2201) sent via a data cable (1604) (2202) or wirelessly through the Tx/Rx circuit (1204) into the data processing/control circuit (1202). Otherwise, it performs artificial intelligence-driven evaluations to determine the suitable spatial variation direction and degree required to pass through the desired path.

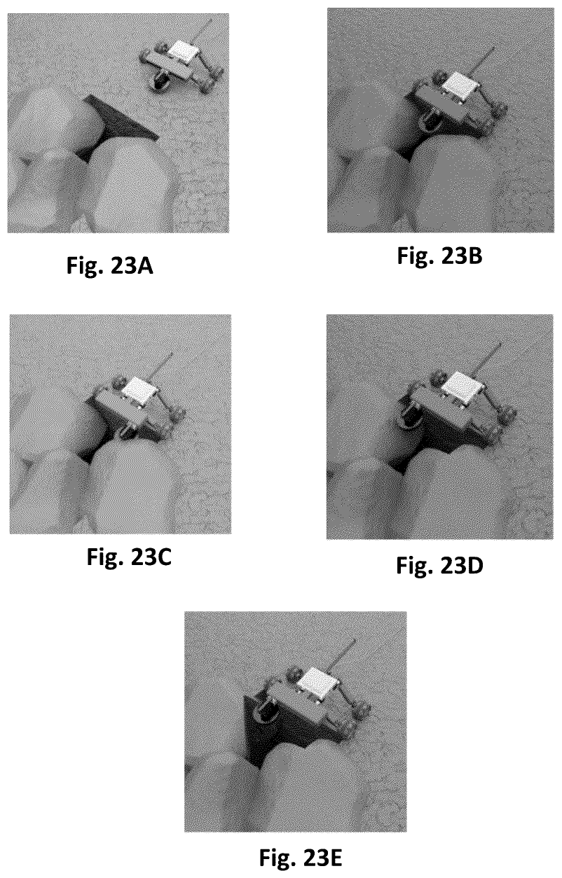

FIGS. 23A-23E show robotic system carving a path through a ground opening according to an embodiment of the present disclosure.

The robot in on the scene approaching the path to be carved (FIG. 23A), approaching the surface opening (FIG. 23B), performing a right-side carving (FIG. 23C), performing a left-side carving (FIG. 23D), and has now created a path through which the robot can now enter (FIG. 23E).

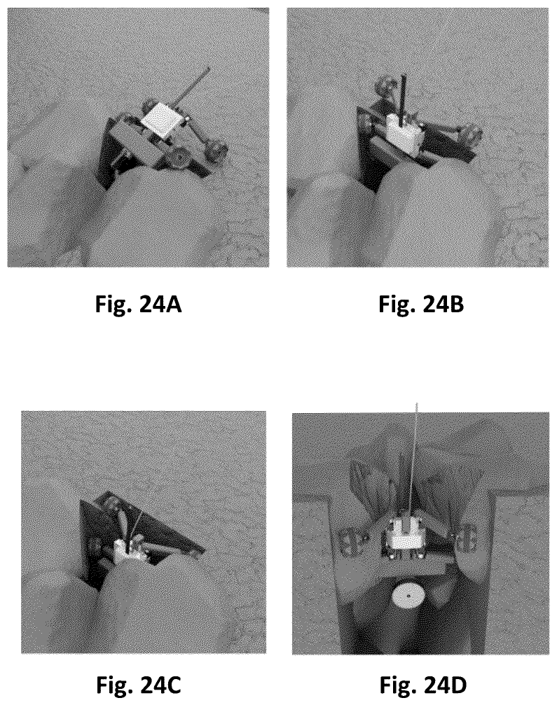

FIGS. 24A-24D show the robotic system performing manipulations on the robotic arms according to an embodiment of the present disclosure.

The robotic system performs remote controlled/automated manipulations on the robotic arms location and wheels orientation (FIG. 24A), then enters the created path (FIG. 24B). The robot adjusts its robotic arms and wheels orientation to fit in the created opening (FIG. 24C). What is then shown is a cross-section of the robot while passing through the created path (FIG. 24D).

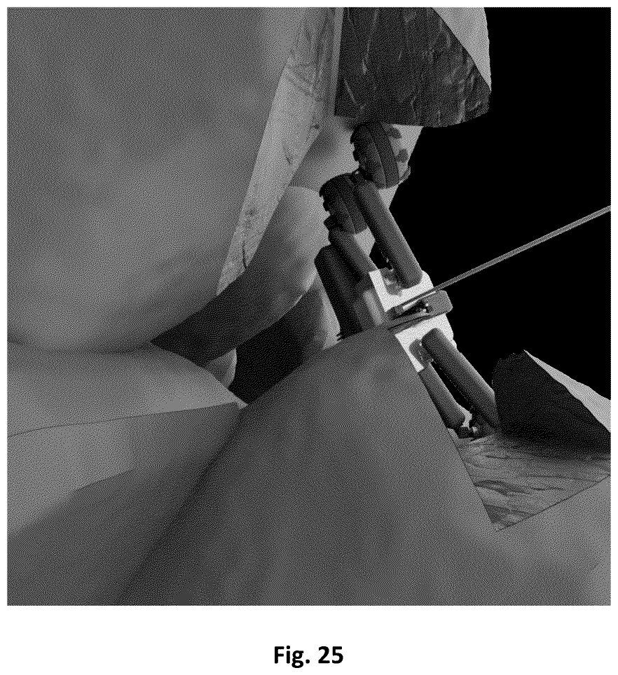

FIG. 25 shows the robotic system collecting GPR readings from underground layers according to an embodiment of the present disclosure.

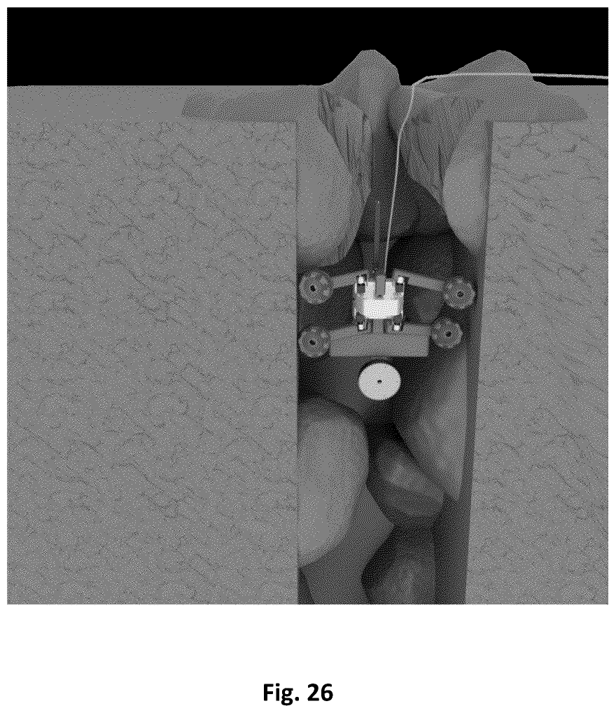

FIG. 26 shows the robotic system passing through a vertical path according to an embodiment of the present disclosure.

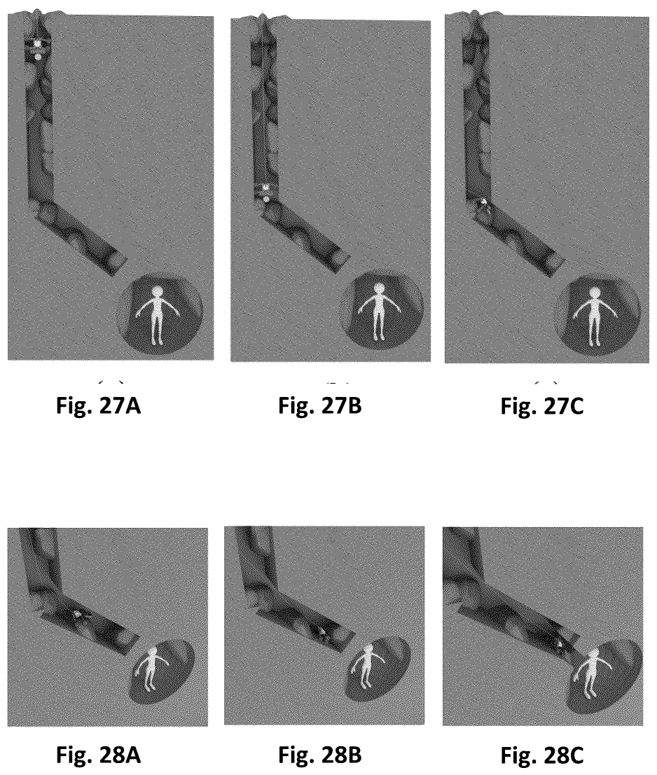

FIGS. 27A-27C show an illustration of the robotic system carving a path through underground layers according to an embodiment of the present disclosure.

FIGS. 28A-28C show an illustration of the robotic system avoiding path obstacles according to an embodiment of the present disclosure.

The robot is avoiding path obstacles (FIG. 28A), arriving at the final barrier to the target location (FIG. 28B), and carving a path to the trapped individual (FIG. 28C).

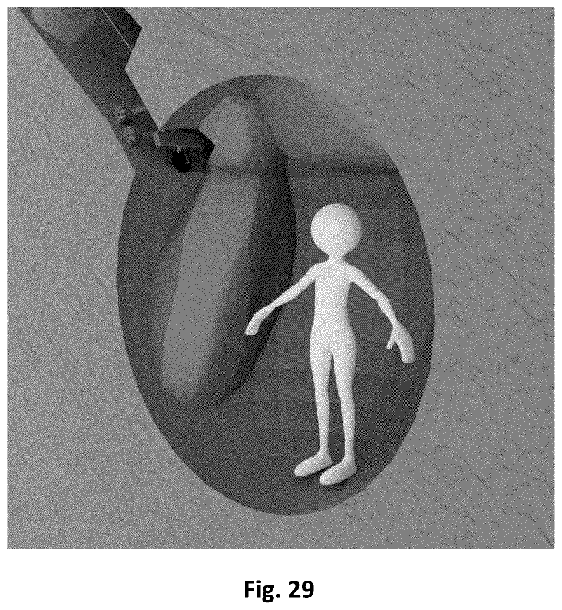

FIG. 29 shows the robotic system arriving at a trapped individual according to an embodiment of the present disclosure.

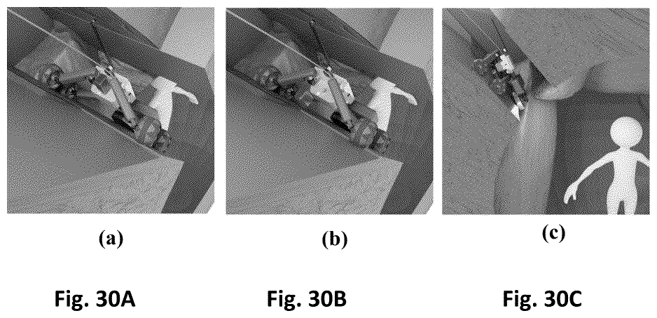

FIGS. 30A-30C show an illustration of the aid package release mechanism according to an embodiment of the present disclosure.

The aid package is attached to the robot (FIG. 30A), the attachment mechanism is activated, and the aid package is dropped (FIG. 30B), and the aid package slides down to the trapped individual (FIG. 30C).

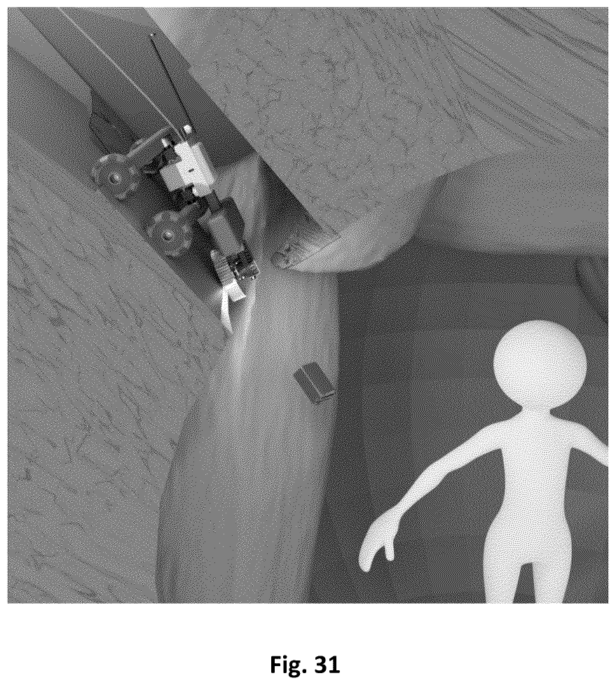

FIG. 31 shows the robotic system delivering aid to a trapped individual according to an embodiment of the present disclosure.

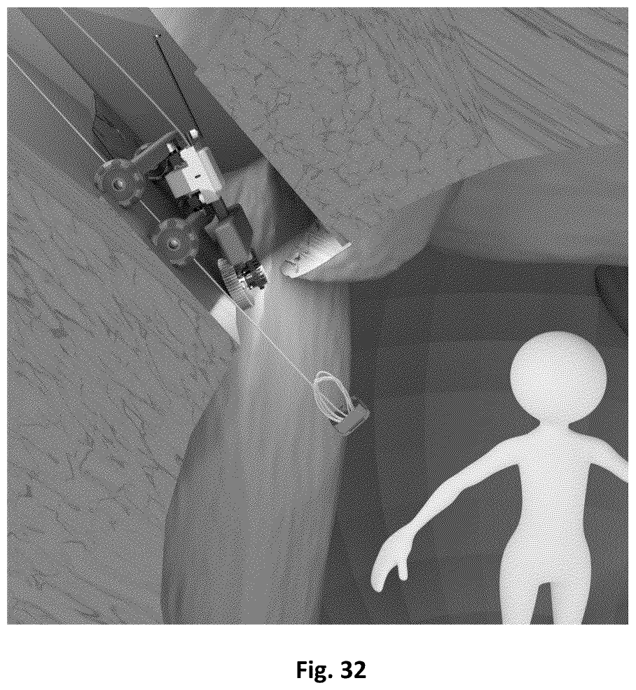

FIG. 32 shows the robotic system delivering rescue ropes or oxygen piped to a trapped individual according to an embodiment of the present disclosure.

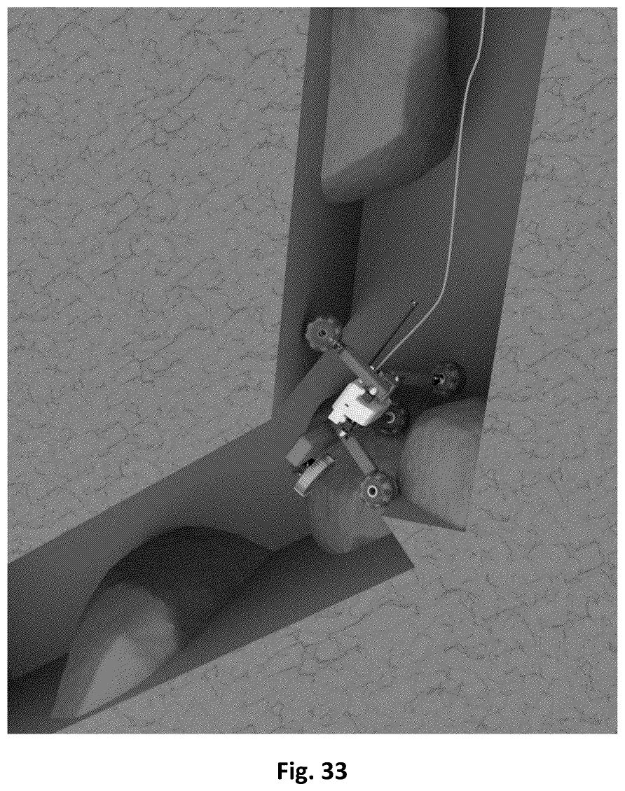

FIG. 33 shows the robotic system performing complex underground spatial manipulations according to an embodiment of the present disclosure.

FIG. 34 shows a flowchart of the operation of the robotic system according to an embodiment of the present disclosure.

Various advantages of a robotic system according to embodiments of the present disclosure will be apparent. Enhanced Inspection Capabilities: Traditional GPR inspection methods are limited to surface layers, but the robotic system of embodiments of the present disclosure can fit into tight spaces and deeper layers, providing more detailed and accurate scans of subsurface structures, materials, and anomalies. This is crucial for assessing infrastructure integrity, identifying hazards, and uncovering archaeological artifacts.

Dual Functionality in Rescue Operations: Apart from its inspection capabilities, the robotic system serves as a vital tool in rescue missions. It can swiftly navigate underground areas to deliver aid to individuals trapped in subterranean layers, including first aid, food, water, and essential rescue equipment. Its agility in carving pathways facilitates the extraction process, ensuring the safe retrieval of those in distress.

Cost Effectiveness and Efficiency: By combining inspection and rescue functionalities, the system offers cost-effective solutions for various scenarios. It minimizes the need for human entry into hazardous environments, enhances safety, and achieves a quick response time during rescue missions. Versatility and Remote Operation: The robot's versatility makes it valuable in routine inspections as well as high-stakes rescue operations. Operators can remotely control the robot, allowing real-time monitoring. Alternatively, the robot relies on artificial intelligence-driven automation to navigate the path, thus enhancing safety and efficiency.

Exploration and Discovery Potential: This system opens up previously inaccessible areas for GPR readings, potentially uncovering new anomalies, minerals for commercial purposes, and facilitating more accurate measurements. It marks a significant advancement in GPR technology, promising expanded possibilities for exploration, research, and discovery in various fields. For instance, the invention opens the door to the fully/partially automated evaluation of structures such as rocky formations with cavities, demolished buildings during disaster response, uneven landscapes used for mining or agricultural purposes and complex archeological sites.

Embodiments of the present disclosure will be described as follows:

Embodiment 1: an agile robotic system engineered with multiple degrees of spatial freedom and structural flexibility, tailored for inspecting confined spaces utilizing Ground Penetrating Radar (GPR) technology, comprising 4 major components, namely, robotic arms and rotational wheels, a path carving mechanism, an aid package dropping mechanism, a main body and control circuits, and a scorpion-tail robotic camera arm.

Embodiment 2: an agile robotic system according to the first embodiment, wherein the robotic system further serves as an asset in rescue missions and disaster response, where it carves an underground path to reach individuals trapped in subterranean layers.

Embodiment 3: an agile robotic system according to the second embodiment, wherein the system comprises a servo motor-rod mechanism that attaches an aid package/rescue ropes/oxygen pipes to the robot's main body.

Embodiment 4: an agile robotic system according to the third embodiment, wherein when the robot arrives to the target, the servo motor performs a 90-degree rotation thus detaching the package and delivering it to the trapped individuals.

Embodiment 5: an agile robotic system according to the first embodiment, wherein the robot operates in automated/remotely-controlled modes, where the spatial manipulations of the robotic arms (406) and rotational wheels (407) are performed either through human operator instructions (2201) sent via a data cable (1604) (2202) or wirelessly through the Tx/Rx circuit (1204) into the data processing/control circuit (1202).

Embodiment 6: an agile robotic system according to the first embodiment, wherein the robot performs artificial intelligence-driven evaluations to determine the suitable spatial variation direction and degree required to pass through the desired path.

Embodiment 7: an agile robotic system according to the first embodiment, wherein the robot further performs path carving using a drilling motor with excavation blade, controlled via the data processing/control circuit.

Embodiment 8: an agile robotic system according to the seventh embodiment, wherein the rotation of the excavation blade dismantles the path obstacles into small fragments, and a linear actuator moves the drilling motor in a straight line in the left-right direction to clear the path.

Embodiment 9: an agile robotic system according to the first embodiment, wherein the robot comprises a long-range depth camera attached through a long rod to servo motors in the main body, which mimics a scorpion tail; a servo motor that controls left-right rotation of the long rod; and another perpendicular servo motor that controls up-down rotations.

Embodiment 10: an agile robotic system according to the ninth embodiment, wherein in addition to the long rod's spatial variation, the camera holder itself is equipped with a robotic left-right and up-down rotation mechanisms to achieve the best field of view coverage.

Embodiment 11: an agile robotic system according to the first embodiment, wherein the robot consists of 4 robotic arms which perform right-left rotation using a servo motor, wherein the robotic arms perform up-down rotation using another servo motor connected to the main body, wherein all servo motors are controlled using the data processing/control circuit, which receives instructions wirelessly via the Tx/Rx circuit (1204) or through human operator instructions (2201) transmitted via a data cable (1604) (2202), or performs artificial intelligence-driven evaluations to determine the suitable spatial variation needed to fit the path.

The present disclosure relates to an agile robotic system engineered with structural flexibility having at least four wheels at the end of independently movable robotic arms for ground penetrating radar inspection. The robotic system is configured to inspect confined spaces and conduct rescue operations in underground environments where traditional inspection methods may be limited or ineffective. Ground Penetrating Radar (GPR) technology is utilized in various civil engineering applications, including evaluation of pipelines, underground utilities, pavement structures, and oil and gas industry infrastructure. Conventional GPR inspection techniques may be confined to surface-level operations due to limitations in existing antenna carrying platforms such as carts, vehicles, or aerial drones. These traditional platforms struggle to navigate into tight spaces or confined areas where subsurface information may be located.

The proposed robotic system combines GPR technology with enhanced mobility capabilities and excavation functionality to access previously inaccessible underground areas. The system is configured to navigate through tight spaces and deeper underground layers, providing detailed scanning capabilities of subsurface structures, materials, and anomalies. The structural flexibility of the robotic arms allows the system to adapt to various terrain conditions and spatial constraints encountered in underground environments. In addition to inspection capabilities, the robotic system serves dual functionality in rescue operations and disaster response scenarios and is configured to carve pathways through underground obstacles and deliver aid to individuals who may be trapped in subterranean locations. The mobility and excavation capabilities facilitate access to areas that may be dangerous or inaccessible to human rescue personnel.

The proposed robotic system operates through remote control mechanisms or artificial intelligence-driven automation, allowing operators to maintain safe distances from hazardous environments while conducting inspection or rescue operations. The combination of GPR inspection technology, structural flexibility, and excavation capabilities provide enhanced understanding and analysis of subsurface environments while expanding possibilities for exploration, research, and emergency response applications. The robotic system provides enhanced inspection capabilities compared to conventional GPR methods that may be limited to surface-level scanning. Traditional GPR inspection platforms include wheeled carts, inspection vehicles, or drone-mounted systems that may encounter limitations when attempting to access confined underground spaces or navigate through irregular terrain conditions. The structural flexibility of the proposed robotic arms enables the system to adapt to various spatial configurations and terrain challenges that may be encountered during underground operations. Each robotic arm is independently controllable, allowing the system to adjust wheel positioning and orientation to accommodate narrow passages, uneven surfaces, or obstacles that may be present in underground environments.

The excavation capabilities of the system allow for active path creation and obstacle removal during inspection or rescue operations. The excavation assembly is configured to dismantle barriers or debris that may obstruct access to target areas, enabling the system to reach locations that may otherwise be inaccessible to conventional inspection equipment or rescue personnel. The dual functionality of the robotic system provides cost-effective solutions for organizations that may require both inspection and emergency response capabilities. The system minimizes the need for human personnel to enter potentially hazardous underground environments while maintaining the ability to conduct thorough subsurface evaluations and deliver aid to individuals who may be trapped in underground locations. Remote operation capabilities allow operators to control the robotic system from safe distances while maintaining real-time monitoring of underground conditions. In another embodiment, the system also incorporates artificial intelligence-driven automation features that may enable autonomous navigation and decision-making capabilities when direct operator control may not be feasible or practical. The robotic system is applicable to various fields including infrastructure assessment, archaeological exploration, mining operations, disaster response, and search and rescue missions. The versatility of the system allows for deployment in diverse underground environments ranging from natural cave systems to collapsed building structures or industrial facilities.

The present disclosure relates to an agile robotic system engineered with structural flexibility having at least four wheels at the end of independently movable robotic arms for ground penetrating radar inspection. The robotic system is configured to provide enhanced subsurface inspection capabilities in environments where conventional GPR equipment may encounter operational limitations or access restrictions. The robotic system is designed to address challenges associated with inspecting confined underground spaces and conducting rescue operations in subterranean environments. Traditional GPR inspection methods may be constrained to surface-level operations, limiting the ability to obtain detailed subsurface information from deeper underground layers or tight spaces where conventional equipment may not be able to operate effectively.

The system combines Ground Penetrating Radar technology with advanced mobility capabilities and excavation functionality to access previously inaccessible underground areas. The structural flexibility of the robotic arms enables the system to navigate through narrow passages, irregular terrain, and confined spaces that may be encountered in underground environments. Each robotic arm may be independently controllable and provides multiple degrees of freedom relative to the main body of the system. The wheels located at the distal ends of the robotic arms may allow for adaptive positioning and orientation adjustments that may be needed to navigate through challenging underground terrain conditions. The excavation capabilities integrated into the robotic system enables active path creation and obstacle removal during inspection or rescue operations. The excavation assembly may be configured to clear debris, dismantle barriers, or carve pathways through underground materials to facilitate access to target areas that may otherwise be unreachable. The dual functionality of the robotic system provides both inspection and emergency response capabilities within a single platform. The system is configured to conduct thorough GPR inspections of subsurface structures while also serving as a tool for delivering aid to individuals who may be trapped in underground locations during emergency situations.

The robotic system may operate through remote control mechanisms that may allow operators to maintain safe distances from potentially hazardous underground environments. The system may also incorporate artificial intelligence-driven automation features that may enable autonomous navigation and decision-making capabilities when direct operator control may not be practical or available. The combination of GPR inspection technology, structural flexibility, mobility capabilities, and excavation functionality may provide enhanced understanding and analysis of subsurface environments while expanding possibilities for exploration, research, infrastructure assessment, and emergency response applications in various underground settings. The robotic system includes a main body that houses and supports various integrated components for ground penetrating radar inspection and control operations. The main body may serve as a central platform that connects and coordinates the functionality of multiple subsystems within the robotic system.

A Ground Penetrating Radar antenna is mounted on the main body to provide subsurface inspection capabilities. The GPR antenna is configured to transmit electromagnetic pulses into subsurface materials and receive reflected signals to generate imaging data of underground structures, materials, and anomalies. The antenna may be positioned on the main body to maintain proper coupling with inspected surfaces while allowing the robotic system to navigate through various terrain conditions. The main body incorporates control circuits that manage the operation and coordination of the robotic system components. The control circuits may include a data processing/control circuit that receives and processes input signals from various sensors and control interfaces. The data processing/control circuit may be configured to analyze video feeds, process GPR data, and coordinate movement commands for the robotic arms and excavation systems.

In an embodiment, a battery is housed within or connected to the main body to provide electrical power for system operations. The battery supplies power to the servo motors, control circuits, sensors, and other electrical components of the robotic system. A voltage regulator circuit is integrated with the power system to maintain stable voltage levels across different components and ensure proper electrical operation under varying load conditions. The robotic system further includes a Tx/Rx circuit that enables wireless communication capabilities. The Tx/Rx circuit is configured to receive control instructions from remote operators and transmit operational data, video feeds, and status information back to control stations. The wireless communication functionality may allow operators to maintain safe distances from hazardous environments while controlling the robotic system.

A GPS module is further incorporated within the main body to provide location tracking and navigation capabilities. The GPS module facilitates extraction and recovery of the robotic system after completion of inspection or rescue operations. The positioning information may also be used for mapping and documentation of inspection areas and discovered anomalies. The robotic system is configured with dual power options to accommodate different operational scenarios. In some cases, the system may receive power through a data cable that carries a parallel power cable, providing continuous power supply for extended operations. Alternatively, the system may operate using the on-board battery in conjunction with the voltage regulator circuit for autonomous operations in locations where cable connections may not be practical or safe. The dual power options may be selectable based on operational requirements, environmental conditions, and mission parameters that may vary between different inspection and rescue scenarios. The power system flexibility may enable operators to choose the most appropriate power supply method for specific operational conditions while maintaining full system functionality regardless of the selected power option. The adaptable power system design may enhance the versatility and operational effectiveness of the robotic system across diverse underground environments and mission requirements.

The present disclosure relates to an agile robotic system engineered with structural flexibility having at least four wheels at the end of independently movable robotic arms for ground penetrating radar inspection. The robotic system is configured to address limitations encountered by conventional Ground Penetrating Radar inspection methods that may be restricted to surface-level operations and may lack the mobility to access confined underground spaces. The robotic system is designed to inspect confined spaces and conduct rescue operations in underground environments where traditional inspection equipment may encounter operational constraints. Conventional GPR platforms such as wheeled carts, inspection vehicles, and drone-mounted systems may struggle to navigate through tight passages, irregular terrain, or confined areas where subsurface information may be located. The proposed system combines Ground Penetrating Radar technology with enhanced mobility capabilities and excavation functionality to provide access to previously inaccessible underground areas. The structural flexibility of the independently movable robotic arms may enable the system to adapt to various spatial configurations and terrain challenges that may be encountered during underground operations.

Each robotic arm is configured to provide multiple degrees of freedom relative to the main body, allowing for adaptive positioning and orientation adjustments of the wheels. The independent controllability of the robotic arms enables the system to navigate through narrow passages, uneven surfaces, and obstacles that may be present in underground environments. The excavation capabilities integrated into the robotic system enable active path creation and obstacle removal during inspection or rescue operations. The excavation functionality allows the system to dismantle barriers, clear debris, or carve pathways through underground materials to facilitate access to target areas that may otherwise be unreachable by conventional inspection equipment. The robotic system serves dual functionality by providing both subsurface inspection capabilities and emergency response functionality within a single platform. The system may be configured to conduct thorough GPR inspections of underground structures while also serving as a tool for delivering aid to individuals who may be trapped in subterranean locations during emergency situations.

The combination of GPR inspection technology, structural flexibility, mobility capabilities, and excavation functionality provide enhanced understanding and analysis of subsurface environments. The proposed system expands possibilities for exploration, research, infrastructure assessment, and emergency response applications in various underground settings where conventional methods may be limited or ineffective. The robotic system further comprises a plurality of wheel assemblies connected to the main body, where each wheel assembly may include an arm, and a wheel located at a distal end of the arm. The plurality of wheel assemblies provides enhanced mobility and adaptability for navigating through various underground terrain conditions and confined spaces that may be encountered during inspection or rescue operations.

In another embodiment, the robotic system may comprise more than two wheels to provide increased stability and maneuverability in challenging underground environments. In some cases, the robotic system may comprise more than three wheels to further enhance the system's ability to maintain contact with irregular surfaces and navigate through complex terrain configurations. The robotic system may comprise four wheels, where each wheel may be positioned at the distal end of a corresponding robotic arm to provide distributed support and traction across the main body of the system. Each arm of each wheel assembly may be connected to the main body by a servo motor assembly that provides controlled movement and positioning capabilities. The servo motor assembly may be configured such that each arm of each wheel assembly has two degrees of freedom relative to the main body, allowing for independent adjustment of arm position and orientation to accommodate varying terrain conditions and spatial constraints. The servo motor assembly may include a first servo motor that controls right-left rotation of the robotic arm relative to the main body. The right-left rotation capability may allow each arm to be positioned laterally to adjust the overall width and configuration of the robotic system as needed for navigation through narrow passages or around obstacles that may be encountered in underground environments.

The servo motor assembly may also include a second servo motor that controls up-down rotation of the robotic arm relative to the main body. The up-down rotation capability may enable each arm to be raised or lowered independently, allowing the robotic system to adapt to uneven terrain, climb over obstacles, or adjust the positioning of the wheels to maintain proper contact with surfaces during inspection operations. The combination of right-left rotation and up-down rotation provided by the servo motor assembly may enable each robotic arm to be positioned in various spatial configurations to optimize the system's mobility and stability under different operational conditions. The independent control of each arm may allow the robotic system to perform complex maneuvers and adapt to challenging terrain that may be encountered in underground environments.

Each wheel may be movable relative to the respective arm to provide additional positioning flexibility and enhanced traction capabilities. The movability of each wheel relative to the respective arm may allow for fine adjustments in wheel orientation and contact angle to optimize traction and stability on various surface types and terrain conditions that may be encountered during operations. In some cases, each wheel may be movable in two degrees of freedom relative to the respective arm. The two degrees of freedom for wheel movement may be provided through additional servo motors that control wheel positioning and orientation independently of the arm positioning. The additional degrees of freedom for wheel movement may enhance the system's ability to maintain optimal contact with surfaces and navigate through complex terrain configurations.

A pair of servo motors may be associated with each wheel to provide the two degrees of freedom for wheel movement relative to the respective arm. The pair of servo motors may include a first servo motor that controls rotation of the wheel in a first direction relative to the arm, and a second servo motor that controls rotation of the wheel in a second direction relative to the arm. The independent control of wheel orientation through the pair of servo motors may allow for precise adjustment of wheel positioning to optimize traction and maneuverability. The robotic arms may be configured to perform various positioning adjustments to accommodate different operational modes and terrain conditions. The robotic arms may be adjusted to perform flat surface evaluation in addition to tight space inspection, providing versatility for different types of ground penetrating radar inspection applications that may be encountered in various environments.

In surface scanning mode configuration, the robotic arms may be positioned to allow the robotic system to operate effectively on relatively flat terrain surfaces. The arms may be adjusted to position the wheels in a stable configuration that maintains proper contact with the surface while allowing the GPR antenna to maintain appropriate coupling with the ground for effective subsurface scanning operations. The transition to surface scanning mode may involve coordinated movement of multiple robotic arms to achieve a stable and effective configuration for surface-level GPR inspection. The servo motor assemblies may coordinate the positioning of each arm to ensure that the robotic system maintains proper balance and stability while conducting surface scanning operations on various types of terrain.

In another embodiment, the robotic system includes an excavation assembly connected to the main body that provides path creation and obstacle removal capabilities during inspection or rescue operations. The excavation assembly may be configured to actively clear pathways through underground materials and dismantle barriers that may obstruct access to target areas during subsurface operations. The excavation assembly comprises an actuator and an excavation tool operably movable by the actuator. The actuator may be configured to control the positioning and movement of the excavation tool to enable effective clearing of obstacles and debris that may be encountered in underground environments. The operable movement of the excavation tool by the actuator may allow for precise control of excavation operations during navigation through confined spaces.

The excavation tool may comprise an excavation blade that provides cutting and dismantling capabilities for various types of underground materials and obstacles. The excavation blade may be configured to engage with soil, debris, rock fragments, and other materials that may obstruct the path of the robotic system during underground operations. The design of the excavation blade may enable effective material removal while maintaining durability under challenging operational conditions. In an embodiment, a drilling motor may be attached to the excavation blade to provide rotational power for excavation operations. The drilling motor may be configured to rotate the excavation blade at controlled speeds to achieve effective material removal and obstacle dismantling. The attachment of the excavation blade to the drilling motor provides a robust connection that can withstand the forces generated during excavation operations in various underground materials.

The drilling motor may operate at high speed to dismantle obstacles into small fragments that can be more easily cleared from the path of the robotic system. The high-speed operation of the drilling motor may enable efficient breakdown of larger obstacles into manageable pieces that do not impede the progress of the robotic system through underground passages. The fragmentation of obstacles may facilitate continued navigation and access to target areas during inspection or rescue operations. The excavation assembly further includes a linear actuator that provides controlled movement of the drilling motor and attached excavation blade. The linear actuator may be configured to move the drilling motor in a straight-line motion to enable systematic clearing of pathways and obstacles. The linear movement capability may allow the excavation assembly to cover a wider area during clearing operations and ensure thorough removal of obstructing materials.

The robotic system further includes multiple depth cameras mounted on the main body to provide comprehensive visual monitoring capabilities during underground operations. The depth cameras are configured to capture video feed that enables computer vision analysis of the inspection path and surrounding underground environment. The video feed from the depth cameras may provide real-time visual information that supports navigation decisions and obstacle detection during subsurface operations. The depth cameras are strategically positioned on the main body to provide optimal coverage of the areas surrounding the robotic system during underground navigation. The positioning of multiple depth cameras enables comprehensive monitoring of the path ahead, sides, and other areas that may be relevant for safe and effective navigation through confined underground spaces. The multiple camera configuration may reduce blind spots and enhance the overall situational awareness capabilities of the robotic system.

Computer vision analysis may be performed on the video feed obtained from the depth cameras to support automated navigation and decision-making capabilities. The computer vision processing may analyze the visual information to identify obstacles, assess path conditions, and determine appropriate navigation strategies for the robotic system. The analysis of the video feed may enable the system to make informed decisions about arm positioning, wheel orientation, and excavation operations based on the observed underground conditions. In another embodiment, the depth cameras provide input for artificial intelligence-driven evaluations that determine suitable spatial variation directions and degrees for navigating through underground passages. The visual information from the cameras is processed to assess the dimensions and characteristics of available pathways, enabling the system to automatically adjust the positioning of robotic arms and wheels to accommodate the observed spatial constraints.

Additional depth cameras are mounted on the excavation assembly to provide focused monitoring of excavation operations and path clearing activities. The depth cameras on the excavation assembly may capture detailed visual information about the materials and obstacles being encountered during excavation, enabling precise control of the drilling motor and excavation blade operations. The visual feedback from excavation-mounted cameras may enhance the effectiveness of path clearing operations. The video feed from all depth cameras is transmitted to remote operators to enable real-time monitoring and control of the robotic system from safe distances. The transmission of video information allows operators to assess underground conditions, monitor system performance, and make informed decisions about navigation and operational strategies without requiring direct presence in potentially hazardous underground environments.

In another embodiment, the proposed robotic system includes multiple flashlights distributed across various components to provide illumination of the inspection path and surrounding underground environment. The flashlights are configured to ensure adequate lighting conditions for effective camera operation and to support optimum decision making during underground navigation and inspection operations. The illumination provided by the flashlights may be particularly important in underground environments where natural lighting may be limited or absent. The multiple flashlights may be strategically positioned on the main body and other components of the robotic system to provide comprehensive illumination coverage during operations. The distribution of flashlights across the system may ensure that adequate lighting is available for all areas that may be monitored by the depth cameras, enabling effective visual analysis and computer vision processing of the underground environment. The flashlights provide illumination that enhances the quality of video feed captured by the depth cameras, enabling more accurate computer vision analysis of path conditions and obstacles. The adequate lighting provided by the flashlights improve the ability of the computer vision system to identify and analyze features in the underground environment, supporting more effective automated navigation and decision-making capabilities.

The illumination system may be coordinated with the camera system to ensure optimal lighting conditions for various operational scenarios that may be encountered during underground inspection or rescue operations. The flashlights may be configured to provide appropriate lighting levels and distribution patterns that complement the field of view and sensitivity characteristics of the depth cameras, maximizing the effectiveness of the visual monitoring system. The flashlights are powered by the same electrical system that supplies power to other components of the robotic system, including the servo motors, control circuits, and cameras. The integration of the illumination system with the overall power management system ensures consistent and reliable lighting performance throughout the duration of underground operations, supporting continuous visual monitoring capabilities.

In another embodiment, the robotic system includes a scorpion-tail robotic camera arm that provides extended visual monitoring capabilities for enhanced navigation and inspection operations in underground environments. The scorpion-tail robotic camera arm is configured to extend the visual monitoring range of the robotic system beyond the immediate vicinity of the main body, enabling observation of areas that may not be accessible to cameras mounted directly on the main body. A long-range depth camera is incorporated into the scorpion-tail robotic camera arm to provide detailed visual information about distant areas within underground passages and confined spaces. The long-range depth camera is configured to capture high-quality video feed and depth information from extended distances, enabling the robotic system to assess conditions and obstacles that may be encountered ahead of the current position during navigation operations.

The long-range depth camera may be attached through a long rod that provides the physical connection and support structure for the camera positioning system. The long rod may be configured to extend the reach of the depth camera while maintaining structural stability and precise positioning control during camera operations. The attachment of the depth camera through the long rod may enable flexible positioning of the camera at various distances and orientations relative to the main body of the robotic system.

The long rod is connected to servo motors positioned within the main body to provide controlled movement and positioning capabilities for the scorpion-tail robotic camera arm. The servo motors are configured to manipulate the position and orientation of the long rod, thereby controlling the positioning of the attached long-range depth camera. The connection of the long rod to servo motors within the main body provides a stable and controlled actuation system for camera positioning operations. The servo motors controlling the scorpion-tail robotic camera arm provide two degrees of freedom for movement of the long rod and attached camera system. The two degrees of freedom enable comprehensive positioning control that allows the camera to be directed toward various areas of interest within the underground environment. The multiple degrees of freedom enhance the versatility and effectiveness of the visual monitoring capabilities provided by the scorpion-tail camera arm.

The camera holder is positioned at the distal end of the long rod to provide mounting and support for the long-range depth camera. The camera holder is configured to securely maintain the position and orientation of the depth camera while allowing for additional positioning adjustments that may enhance the field of view coverage and visual monitoring capabilities of the scorpion-tail camera arm. Additional servo motor-based rotation mechanisms may be incorporated into the camera holder to provide enhanced positioning control for the long-range depth camera. The additional rotation mechanisms enable fine adjustments to camera orientation that complement the positioning capabilities provided by the servo motors controlling the long rod movement. The servo motor-based rotation mechanisms on the camera holder provide additional degrees of freedom for camera positioning beyond those provided by the long rod control system.

In another embodiment, the proposed robotic system includes an aid package dropping mechanism that provides delivery capabilities for rescue operations in underground environments. The aid package dropping mechanism is configured to transport and deliver various types of aid materials to individuals who may be trapped in subterranean locations during emergency situations. The mechanism enables the robotic system to serve dual functionality by combining ground penetrating radar inspection capabilities with emergency response and rescue support operations. The aid package dropping mechanism comprises a servo motor-rod mechanism that provides controlled attachment and detachment capabilities for various types of aid materials. The servo motor-rod mechanism may be configured to securely hold aid packages, rescue ropes, or oxygen pipes during transport through underground passages and confined spaces. The mechanism maintains secure attachment of aid materials during navigation operations while providing reliable release functionality when the robotic system reaches target locations where aid delivery may be needed.

The aid package dropping mechanism is specifically designed to support rescue operations where the robotic system may need to deliver aid to individuals trapped in underground layers. The mechanism enables the robotic system to transport emergency supplies through confined underground passages and deliver the materials to locations where trapped individuals may be located. The delivery capability provides a means of supplying aid materials to areas that may be inaccessible or dangerous for human rescue personnel.

Rescue ropes may be transported and delivered using the aid package dropping mechanism to provide means for trapped individuals to secure themselves or to facilitate extraction operations by rescue personnel. The mechanism may be configured to transport coiled rescue ropes through underground passages and release the ropes at locations where they may be accessed by trapped individuals or used by rescue teams for extraction operations. Oxygen pipes may be transported and delivered by the aid package dropping mechanism to provide breathing support for individuals who may be trapped in underground environments with limited air supply. The mechanism may be configured to transport flexible oxygen delivery systems and release them at target locations where trapped individuals may access the oxygen supply. The delivery of oxygen pipes may provide life-sustaining support while other rescue operations are being conducted. The aid package dropping mechanism may operate in coordination with the navigation and positioning systems of the robotic system to ensure accurate delivery of aid materials at target locations. The mechanism may be activated when the robotic system reaches the vicinity of trapped individuals, enabling precise placement of aid materials where they may be most effectively accessed and utilized during rescue operations.

A remote-control mode may be implemented to allow human operators to control the robotic system from safe distances while maintaining direct oversight of underground operations. The remote-control mode may enable operators to make real-time decisions about navigation, excavation, and inspection operations based on visual feedback and operational data transmitted from the robotic system. The remote-control capability may be particularly valuable in hazardous underground environments where direct human presence may pose safety risks. Human operator instructions may also be transmitted to the robotic system through wireless communication channels that maintain connectivity between remote control stations and the underground robotic system. The wireless transmission of control instructions may enable operators to maintain control of the robotic system even when physical cable connections may not be practical or safe due to the underground environment or operational constraints.

In an embodiment, a data processing/control circuit serves as the central control system that receives and processes control instructions from remote operators and coordinates the operation of all robotic system components. The data processing/control circuit is configured to interpret control commands received through wireless or cable communication channels and translate the commands into appropriate control signals for servo motors, excavation systems, and other operational components. The data processing/control circuit coordinates the operation of all servo motors within the robotic system based on control instructions received from remote operators. The coordination of servo motor operations includes controlling the positioning and movement of robotic arms, wheel orientation adjustments, scorpion-tail camera arm positioning, and aid package dropping mechanism operations. The centralized control coordination may ensure synchronized operation of multiple system components during complex navigation and operational maneuvers.

Artificial intelligence-driven evaluations may be performed by the data processing/control circuit to analyze environmental conditions and determine appropriate navigation and operational strategies for the robotic system. The artificial intelligence processing may utilize advanced algorithms and decision-making logic to assess underground conditions and make informed decisions about robotic system operations without requiring continuous direct input from remote operators.

The data processing/control circuit coordinates the operation of the excavation assembly based on control inputs received from either remote operators or artificial intelligence-driven evaluations. The excavation assembly coordination may include controlling the drilling motor speed, excavation blade positioning, and linear actuator movement to achieve effective path clearing and obstacle removal operations. The coordinated control of excavation components ensures efficient and safe excavation operations during underground navigation. All system components may be coordinated through the data processing/control circuit to ensure synchronized and effective operation during both remote control and automated operation modes. The component coordination may include servo motor control for robotic arms and wheels, camera positioning systems, excavation assembly operations, aid package dropping mechanisms, and communication systems. The centralized coordination ensures that all system components work together effectively to achieve operational objectives while maintaining system stability and safety during underground operations.

The coordinated operation of all system components enables the robotic system to function as an integrated platform that combines mobility, excavation, sensing, inspection, and aid delivery capabilities within a single system. The integration of these diverse capabilities provides comprehensive functionality for both routine ground penetrating radar inspection operations and emergency rescue response scenarios where access to confined underground spaces may be required for life-saving operations. The main body serves as a central structural platform that houses and integrates various electronic and mechanical components required for ground penetrating radar inspection and robotic system operations. The main body provides structural support and protection for sensitive electronic components while maintaining a compact configuration that enables navigation through confined underground spaces. The integration of multiple systems within the main body facilitates coordinated operation and efficient space utilization within the overall robotic system design.

Control circuits may be incorporated within the main body to manage and coordinate the operation of all robotic system components during inspection and rescue operations. The control circuits may comprise multiple interconnected electronic systems that provide processing, communication, power management, and navigation capabilities for the robotic system. The integration of control circuits within the main body may provide centralized control functionality while protecting electronic components from environmental hazards encountered in underground operations.

The robotic system receives power through a data cable that carries a parallel power cable, providing continuous power supply for extended operations in underground environments. The data cable power option enables the robotic system to operate for extended periods without battery capacity limitations while maintaining continuous communication connectivity with remote control stations. The cable power supply may be particularly suitable for operations where the robotic system remains within a reasonable distance of support equipment and where cable deployment may be practical. The data cable provides both electrical power and data communication connectivity through a single cable connection, simplifying the connection requirements between the robotic system and external support equipment.

The robotic arms may be positioned to allow the robotic system to operate effectively on relatively flat terrain surfaces where the confined space navigation capabilities may not be required. The arm positioning for surface operations may differ significantly from the configurations used for confined space navigation, requiring coordinated adjustment of multiple arms to achieve optimal surface inspection performance. The positioning flexibility may enable the same robotic system to function effectively in both confined space and surface inspection applications. The robotic system may integrate multiple components to perform comprehensive ground penetrating radar inspection operations in confined underground spaces through coordinated system functionality. The integration of excavation capabilities, structural flexibility, mobility systems, and GPR technology may enable the robotic system to access and inspect areas that may be inaccessible to conventional inspection equipment or methods.

Many changes, modifications, variations and other uses and applications of the present disclosure will become apparent to those skilled in the art after considering this specification and the accompanying drawings, which disclose the preferred embodiments thereof. All such changes, modifications, variations and other uses and applications, which do not depart from the spirit and scope of the present disclosure, are deemed to be covered by the invention, which is to be limited only by the claims which follow.

1. A robotic system for ground penetrating radar inspection, comprising:
a main body;
a plurality of wheel assemblies connected to the main body, each wheel assembly comprising an arm and a wheel located at a distal end of the arm; and
an excavation assembly connected to the main body, the excavation assembly comprising an actuator and an excavation tool operably movable by the actuator;
wherein each arm of each wheel assembly is connected to the main body by a servo motor assembly, such that each arm of each wheel assembly has two degrees of freedom relative to the main body.

2. The robotic system of claim 1, wherein the plurality of wheel assemblies comprises four-wheel assemblies.

3. The robotic system of claim 1, wherein the servo motor assembly comprises a first servo motor configured to control right-left rotation of the arm relative to the main body and a second servo motor configured to control up-down rotation of the arm relative to the main body.

4. The robotic system of claim 1, wherein each wheel is movable relative to the respective arm.

5. The robotic system of claim 4, wherein each wheel is movable in two degrees of freedom relative to the respective arm.

6. The robotic system of claim 5, wherein each wheel is connected to the respective arm by a pair of servo motors that provide the two degrees of freedom for wheel movement.

7. The robotic system of claim 1, wherein the excavation tool comprises an excavation blade and a drilling motor attached to the excavation blade.

8. The robotic system of claim 7, wherein the actuator comprises a linear actuator configured to move the drilling motor in a straight line in a left-right direction.

9. The robotic system of claim 1, further comprising a ground penetrating radar antenna mounted on the main body.

10. The robotic system of claim 1, further comprising a plurality of depth cameras mounted on the main body.

11. The robotic system of claim 10, further comprising a plurality of flashlights configured to provide illumination for the plurality of depth cameras.

12. A method of performing ground penetrating radar inspection, comprising:
deploying a robotic system, the robotic system comprising a main body and a plurality of wheel assemblies, each wheel assembly comprising an arm and a wheel located at a distal end of the arm;
actuating at least one arm via a servo motor assembly and moving the arm in two degrees of freedom relative to the main body; and
excavating a section of ground using an excavation assembly connected to the main body.

13. The method of claim 12, further comprising a step of collecting ground penetrating radar data from underground layers using a ground penetrating radar antenna mounted on the main body.

14. The method of claim 13, further comprising a step of analyzing video feed from a plurality of depth cameras to determine suitable spatial variation directions for navigating through underground passages.

15. The method of claim 14, further comprising a step of delivering aid materials to individuals trapped in subterranean locations using an aid package dropping mechanism.

16. A robotic system for underground rescue operations, comprising:
a main body housing a ground penetrating radar antenna;
four wheel assemblies connected to the main body, each wheel assembly comprising an arm and a wheel located at a distal end of the arm, wherein each arm is connected to the main body by a servo motor assembly providing two degrees of freedom relative to the main body;
an excavation assembly connected to the main body and comprising a drilling motor, an excavation blade attached to the drilling motor, and a linear actuator configured to move the drilling motor; and
an aid package dropping mechanism comprising a servo motor and an attachment rod configured to secure and release aid materials.

17. The robotic system of claim 16, wherein the servo motor assembly comprises a first servo motor configured to control right-left rotation of the arm relative to the main body and a second servo motor configured to control up-down rotation of the arm relative to the main body.

18. The robotic system of claim 16, wherein each wheel is movable in two degrees of freedom relative to the respective arm via a pair of servo motors.

19. The robotic system of claim 16, further comprising a scorpion-tail robotic camera arm connected to the main body, the scorpion-tail robotic camera arm comprising a long-range depth camera attached through a long rod to servo motors that provide two degrees of freedom for camera positioning.

20. The robotic system of claim 19, wherein the servo motor of the aid package dropping mechanism is configured to perform a 90-degree rotation of the attachment rod to release aid materials selected from the group consisting of first aid supplies, food, water, rescue ropes, and oxygen pipes.
